(19) United States
(12) Patent Application Publication
(10) Pub. No.: US 2008/0134187 A1
(43) Pub. Date: Jun. 5, 2008

(54) HARDWARE SCHEDULED SMP ARCHITECTURES

(75) Inventors: Marcello LAJOLO, PRINCETON, NJ (US); Andre Costi NACUL, IRVINE, CA (US); Francesco REGAZZONI, COLICO (IT)

Correspondence Address: BROSEMER, KOLEFAS & ASSOCIATES, LLC (NECL), ONE BETHANY ROAD BUILDING 4 - SUITE #58, HAZLET, NJ, 07730, US

(73) Assignee: NEC LABORATORIES AMERICA, Princeton, NJ (US)

(21) Appl. No.: 11/947,278

(22) Filed: Nov. 29, 2007

Related U.S. Application Data
(60) Provisional application No. 60/867,600, filed on Nov. 29, 2006.

(51) Int. Cl. G06F 9/46

(52) U.S. Cl. 718/102

(57) ABSTRACT

A symmetric multiprocessor system employing a hardware constituted real-time operating system.

### CROSS REFERENCE TO RELATED APPLICATIONS

This application claims the benefit of U.S. Provisional Application No. 60/867,600 filed Nov. 29, 2007.

### FIELD OF THE INVENTION

This invention relates generally to the field of multiprocessor computing systems and their operating systems. More particularly, it pertains to the implementation of a real-time operating system in a symmetric multiprocessor (SMP) architecture.

### BACKGROUND OF THE INVENTION

Numerous real world applications of computing systems benefit from a multitasking programming environment implemented upon multiprocessing hardware and its associated software. As known and appreciated by those skilled in the art, providing system support for multitasking frequently takes two approaches namely, 1) implementing a software layer that multiplexes hardware among concurrent tasks and 2) providing direct hardware support for the execution of multiple tasks. As sometimes implemented in the art, both approaches may be combined in a single platform, for example a software layer providing multiplexing to multitasking-capable hardware.

Recently multiprocessor architectures have been advantageously supplemented with additional hardware that accelerates multitasking systems and increases their efficiency by freeing the processor(s) from performing multitasking management and/or control. One such architecture which benefits from this approach is a Symmetric Multi-Processor (SMP) architecture which is known by those skilled in the art as an architecture in which all processors the same memory. Continued improvement in multitasking for SMP architectures would represent an advance in the art.

### SUMMARY OF THE INVENTION

An advance is made in the art according to the principles of the present invention directed to a hardware real time operating system (HW RTOS) which advantageously implements the OS layer in a dual-processor SMP architecture. Intertask communication is specified by a dedicated application programming interface (API) wherein the HW-RTOS provides and manages communication requirements of applications while providing task scheduling. Advantageously, when implemented according to the present invention, the HW-RTOS results in systems exhibiting a smaller footprint since there is no need to link final executables to software RTOS libraries as done in the prior art.

### BRIEF DESCRIPTION OF THE DRAWING

A more complete understanding of the present invention may be realized by reference to the accompanying drawings in which:

FIG. 1 is a schematic showing the partitioning of an Operating System Kernel among Hardware and Software functions according to the present invention;

FIG. 2 is a schematic of a an SMP architecture according to the present invention showing dual processors and HW-RTOS;

FIG. 3 is a block diagram depicting the relationships between tasks and HW-RTOS according to the present invention;

FIG. 4 is a block diagram depicting the communication models supported according to the present invention;

FIG. 5 is a block diagram depicting the relationships between underlying architecture, RTOS and applications in systems constructed according to the present invention;

FIG. 6 is a block diagram depicting additional relationships of FIG. 5;

FIG. 7 is a block diagram showing the SMP scheduler of the present invention;

FIG. 8 shows the hardware scheduler according to the present invention;

FIG. 9 is a pseudocode listing of the process associated with suspending a task and performing a context switch;

FIG. 10 is a pseudocode listing of the steps performed in determining the next task to be executed; and

FIG. 11 is a pseudocode listing of the steps performed to compute the next task id.

### DETAILED DESCRIPTION

The following merely illustrates the principles of the invention. It will thus be appreciated that those skilled in the art will be able to devise various arrangements which, although not explicitly described or shown herein, embody the principles of the invention and are included within its spirit and scope.

Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

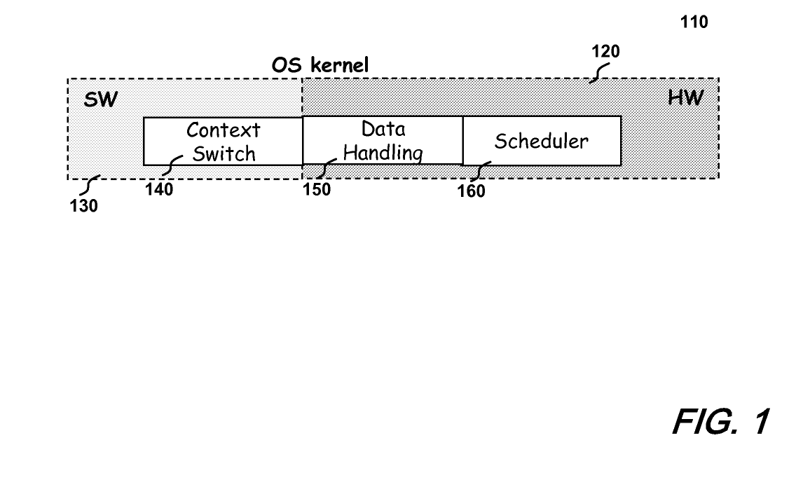

With initial reference now to FIG. 1, there it shows diagrammatically the partitioning of an Operating System Kernel 110 into Hardware 120 and Software 130 according to the present invention. More particularly, and as can be readily appreciated by those skilled in the art, when employed in an embedded system the scheduling performed by an operating system is of paramount importance. In particular, response time and predictability are two important characteristics. According to the present invention, an OS kernel 110 is partitioned into a hardware 120 and software component(s) 130. More specifically, selected functionality namely, data handling 150, scheduling 160 and task communication management (not specifically shown) are migrated into hardware 120 while context switching 140 is maintained in software 130. Advantageously, such migration does not require changes to the central processor (CPU) core while permitting the hardware scheduler 160 to be tailored to a particular embedded application.

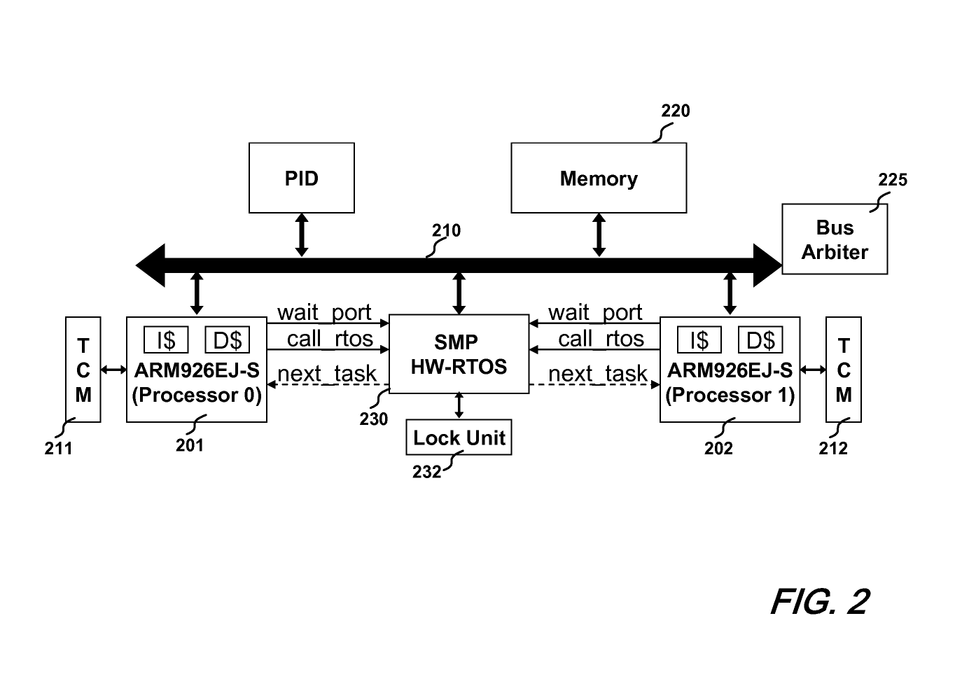

FIG. 2 shows a symmetric multiprocessor (SMP) arrangement according to the present invention. As shown, the arrangement includes two processors 201, 202—which for this example are ARM926EJ-S processors—although those skilled in the art will recognize that different numbers and types of processors may be employed and the invention is not so limited as to the particular number and type of processors shown in this FIG. 2. As shown, the processors include their own caches, while sharing a common bus 210 and memory 220. Bus arbitration may be advantageously provided by bus arbiter 225.

Coordinating communication and resources while managing task scheduling among processors is SMP-HW-RTOS 230 which is an aspect of the present invention. The HW-RTOS 230 employs a hardware locking module or lock unit 232 to control access to shared memory 220 thereby permitting either processor to perform test-and-set operations on the shared memory 220.

As appreciated by those skilled in the art, certain data may be private to a particular processor, i.e., processor ID, and therefore in this example configuration shown in FIG. 2 a tightly coupled memory (TCM) 211, 212 associated with each processor 201, 202 is used. With this configuration, each individual processor 201, 202 may access 2 k of data stored in TCM 211, 212 respectively which is advantageously stored privately. Accordingly, in this configuration, the TCM 211, 212, is directly connected to its respective processor 201, 102, and not to the shared bus 210. In the case of the processor ID, that data is initialized by PID module 215 as each processor 201, 202 initializes.

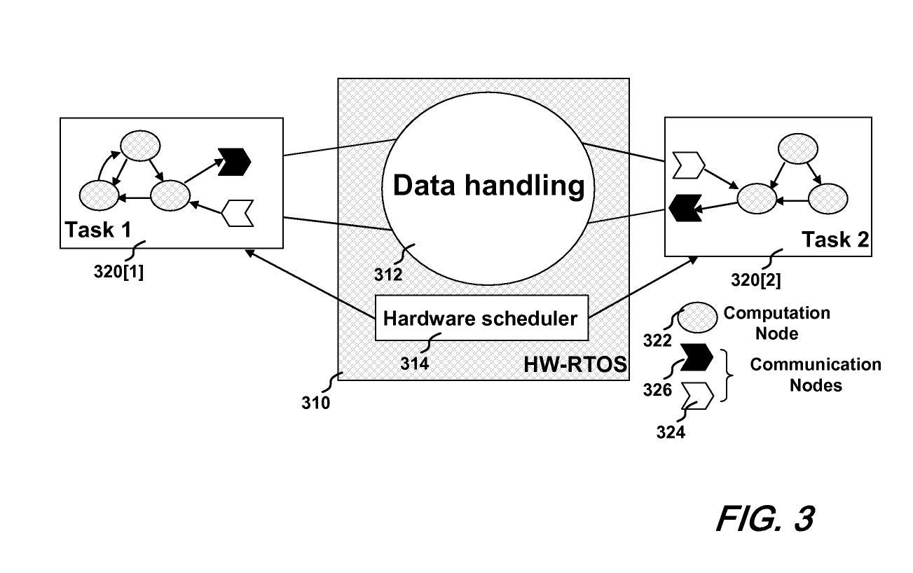

For our purposes as used herein, a system is defined as a set of concurrent, interacting tasks. The tasks may reside in hardware of software. Turning our attention now to FIG. 3, there it shows a block diagram depicting the HW-RTOS of the present invention 310 and its relationship to one or more tasks 320[1], 320[2] within an overall computer system. As can be immediately appreciated, while we have only shown two representative tasks, such systems and our inventive teachings are not so limited. More particularly, the number of tasks within the system may be any number up to a practical amount which may be limited by the number of available processor cycles and memory and/or the size of the HW-RTOS.

As shown in this FIG. 3, the HW-RTOS includes a hardware scheduling function 312 and a data handling function 312 which collectively provides scheduling and data communication between communicating tasks. Tasks are generally thought of as having one or more computation nodes 322 and a set of communication nodes 326, 324 which provide input and output to an individual task, respectively.

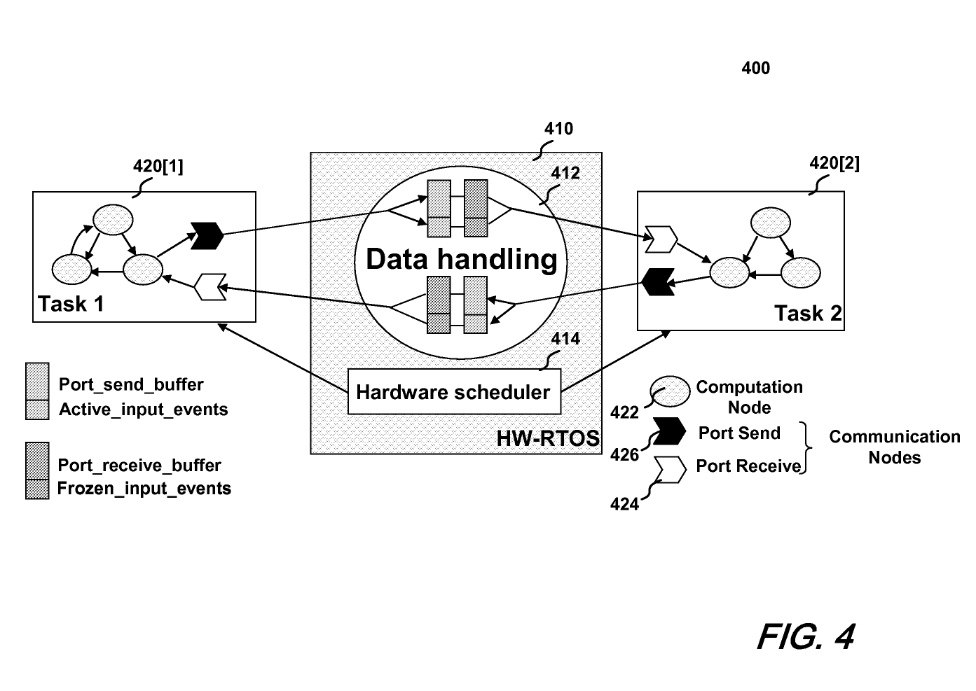

Tasks may advantageously specified in a C-based system design language, or make use of dedicated APIs such as those based upon POSIX for task management and communications. As further used herein, two different communication models are employed namely message passing and shared memory as shown in FIG. 4. As can be understood by those skilled in the art, message passing is abstracted through the use of ports, and provides primitives port_send and port_receive to implement the communication. Blocking and non-blocking styles are supported for port_receive.

A final implementation of APIs for communication and task management is advantageously transparent to the tasks. More particularly, the same application may run in a system with traditional, prior-art libraries as well as in an architecture with hardware accelerators in order to speed up execution. In our exemplary embodiment, we have used the HW-RTOS to improve the efficiently of the OS and API support, transparently to the application. Furthermore the same set of APIs can be used to specify tasks that can later be executed in a single or multiprocessor system—again transparently to the user.

Our inventive implementation comprises two independent scheduling modules, one for each processor in the system. Additionally, and as already shown, the HW-RTOS includes a data handling module, with double buffering to store the data communication between tasks. Before showing additional details diagrammatically however, we first describe an overview of the implementation.

Communication Interface. Each scheduling module of the HW-RTOS communicates with the controlled processor via dedicated ports. As shown in the figures, the ports used to connect each processor with the hardware scheduler are call_rtos; wait_port; and next_task:

Scheduling Granularity. Task scheduling and context switching may occur in at least two cases. First, a task can block when invoking a blocking port_receive call from the communication API. Alternatively, tasks can be preempted if they reach a pre-determined time slice.

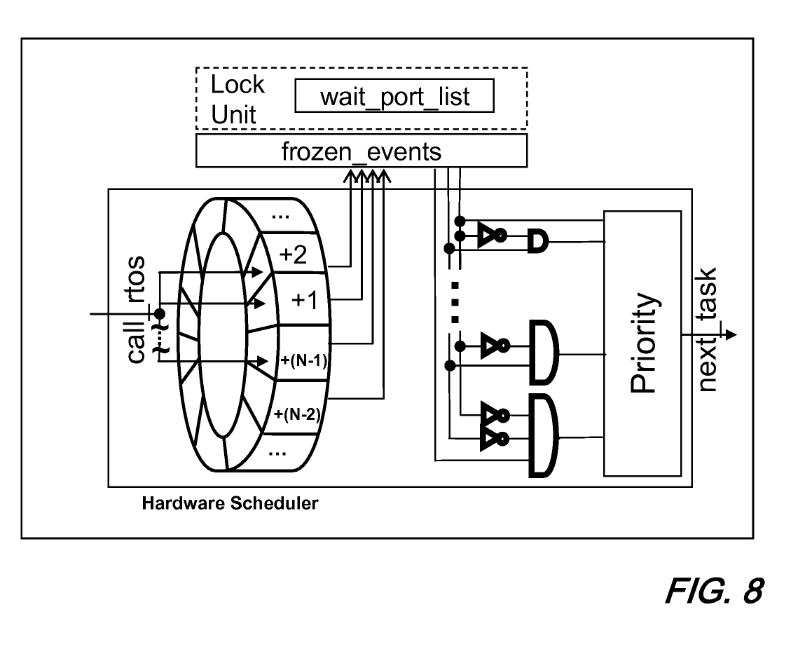

Context Switching. When invoking a blocking port_receive, the blocked task will send the port on which it blocked, waiting for communication via the wait_port signal. The hardware scheduler maintains information regarding the port each task is blocked on the wait_port_list. Immediately after, the task will trigger the hardware scheduler execution via the call_rtos signal. At this time, the hardware will compute the next task to be scheduled in the processor. In order to determine which tasks are able to be scheduled, the hardware reads wait_port_list as shown in FIG. 8. When the scheduling module has determined the next task to be scheduled in the processor, it generates an interrupt to the processor, updates the wait_port_list, and indicates the next task to be executed in the next_task_port.

When a task is preempted for expiring a time slice, an interrupt is generated from the hardware scheduler, along with the next task indication in next_task port. The scheduler will always modify wait_port_list, just after receiving control from the last executed task. Note that when expiring time slice, the task does not send any signal to the HW-RTOS.

Task Context Management. Although the scheduling decision is performed efficiently in hardware, the context save and restore is handled in software because it is not generally possible to access registers in a different way and hence an external module like the HW-RTOS has to leave that context switch task to a dedicated software routine. The software part of the task switching mechanism services the interrupt request generated by the HW-RTOS, saves the processor state for the current task to the shared memory and restores the processor state of the next task from the shared memory. The step of task scheduling is preferably performed in the processor, because it involves reading and writing of the register file and status words, which is not accessible to the HW-RTOS without software intervention.

The context of a task is always saved to the shared memory space. There fore, it is accessible by any processor effectively enabling task migration. Specifically, for the ARM9 architecture, one (1) Kb of space per task is reserved in the shared memory to store a task stack with the context of each task. The values of general purpose registers, (RO-RIO) followed by FP, IP, LR, PC and SPSR registers, are stored in the task's stack before it is preempted from the processor. Additionally, the task's stack pointer SP is stored in a dedicated array, which has one entry per system task, also in the shared memory.

Task Communication. Task communication is handled by a data handling module of the SMP HW-RTOS. Port communication between tasks is controlled by a double buffered scheme. Tasks will write to the send_buffer while they read from the receive_buffer. Similarly, every write will result in an event to be stored in the active_event buffer.

Accordingly, whenever a Task T1 blocks in a port_receive, all of T1's communications will be copied from the send_buffer, to the receive_buffer and immediately become available to all other tasks. Additionally, the corresponding active_event entries are copied to frozen_event, indicating the presence of a new communications event. If any task T2, is waiting on a port that was written by task T1, then T2 will be eligible to be scheduled in the next scheduling cycle. Currently, the scheduling module supports round-robin scheduling. Other policies are possible and may be supported, advantageously without any changes to the interface between the HW-RTOS and the processors.

Note that while there are multiple hardware scheduling modules, one for each processor, there is only one data communication module managing communication from and to every processor. Therefore, there is exactly one copy of send_buffer, receive_buffer, active_event, and frozen_event.

Shared Memory Lock Unit. A dedicated hardware module is employed according the present invention to allow a test-and-set instruction to be implemented. This is an important operation to support shared memory communication in a multiprocessor system as it allows a task to read and subsequently write to a shared memory location without concurrency from other tasks. In a representative embodiment, the lock unit is used to provide test-and-set support for wait_port_list for the SMP HW-RTOS.

For each scheduling module in the SMP HW-RTOS the Lock unit contains one request and one grant bit. The particular address to be locked is specified in the address field. The lock unit is preferably a memory mapped device, so modules can access the bits by reading and writing memory addresses. The implementation of the Lock Unit may be extremely efficient as it generally takes only a single cycle to assert grant bits after the request bit and address are set.

Locking API Primitives. As with communication primitives, tasks use the dedicated API primitives to request locks in the shared memory, specifically shared_memory_lock and shared_memory_unlock. Note that it is the job of the programmer to ensure locking and unlocking requests are properly present in the code. Systems constructed according to the present invention will not automatically detect shared memory access conflicts. Additionally, the lock unit is designed to allow the implementation of a test-and-set instruction, and is not an explicit mutex primitive. Instead, mutexes can be built on top of test-and-set. Therefore it is guaranteed that no context switch happens while performing a test-and-set. For this reason, the lock unit has one entry per processor in the system, instead of one request/grant line per task.

Conflict Resolution. The lock unit implements a priority mechanism to resolve conflicts in shared memory access. If both modules request exclusive access to the same shared memory address, the module with the lowest ID will be granted access to the detriment of the other. In our exemplary implementations, the scheduler module connected to processor ID 0 has higher priority than the module connected to processor with ID 1.

Task Migration. The shared memory in the SMP architecture according to the present invention facilitates task migration, or dynamic task scheduling. All task context information is saved in the shared memory. Therefore, it can be retrieved by any other processor when a task is resumed. It is the scheduler's job to decide whether a task can migrate to another processor, or should resume execution in the same processor it was last executed. Alternatively, the scheduling of tasks to processors may be static, i.e., each task can run only in a single and predetermined processor.

As can be appreciated by those skilled in the art, each approach has its advantages and disadvantages. When tasks migrate, processor resources are better utilized, since any task can be scheduled on any processor. Consequently, all tasks can run, as long as there is a processor available. On the other hand, there is a penalty on cache misses. While in the static scheduling case, there is a chance that task data will still be present in the processor's cache, when tasks migrate, the cache on the new processor will have to be filled with the task's data from the main memory.

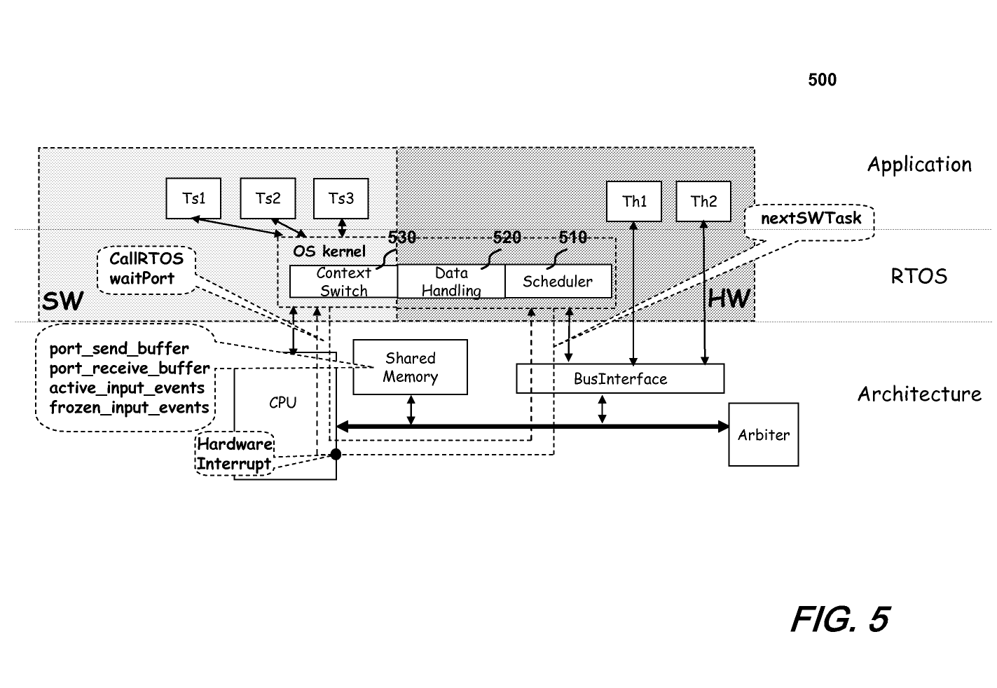

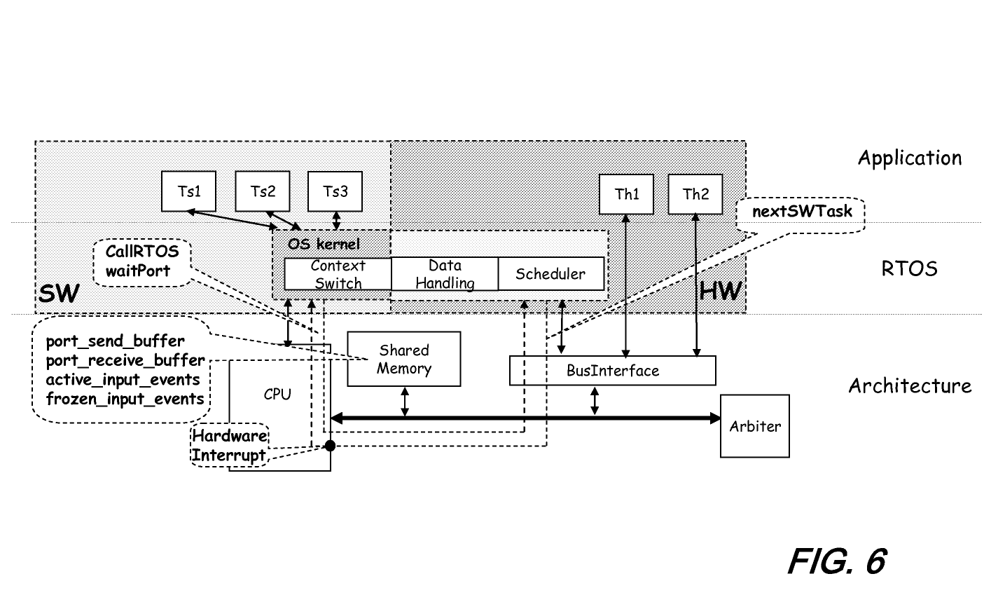

Turning now to FIG. 5, there is shown a block diagram depicting the relationships between underlying architecture, RTOS and applications on a system constructed according to the present invention. As shown, scheduling 510 and data handling functions 520 are hardware functions, while context switching functions 530 are software functions running on the central processor. As depicted in this FIG. 5, CallRTOS and waitPORT are signals directed from the software to the hardware portions of the OS and are routed through the bus. Additionally, nextSWTask is connected to the hardware interrupt port of the CPU buffers and events are handled in the shared memory. These further relationships are shown in the block diagram of FIG. 6.

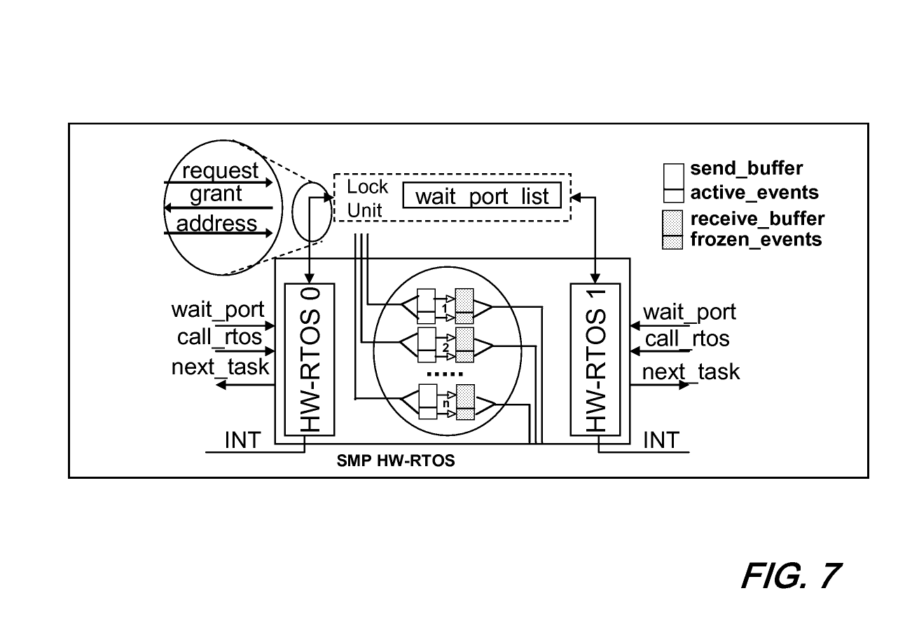

FIG. 7 shows an overview of the SMP scheduler employed according to the present invention. As shown in that FIG. 7, one HW scheduler per processor is employed wherein each includes its own set of corresponding control signals.

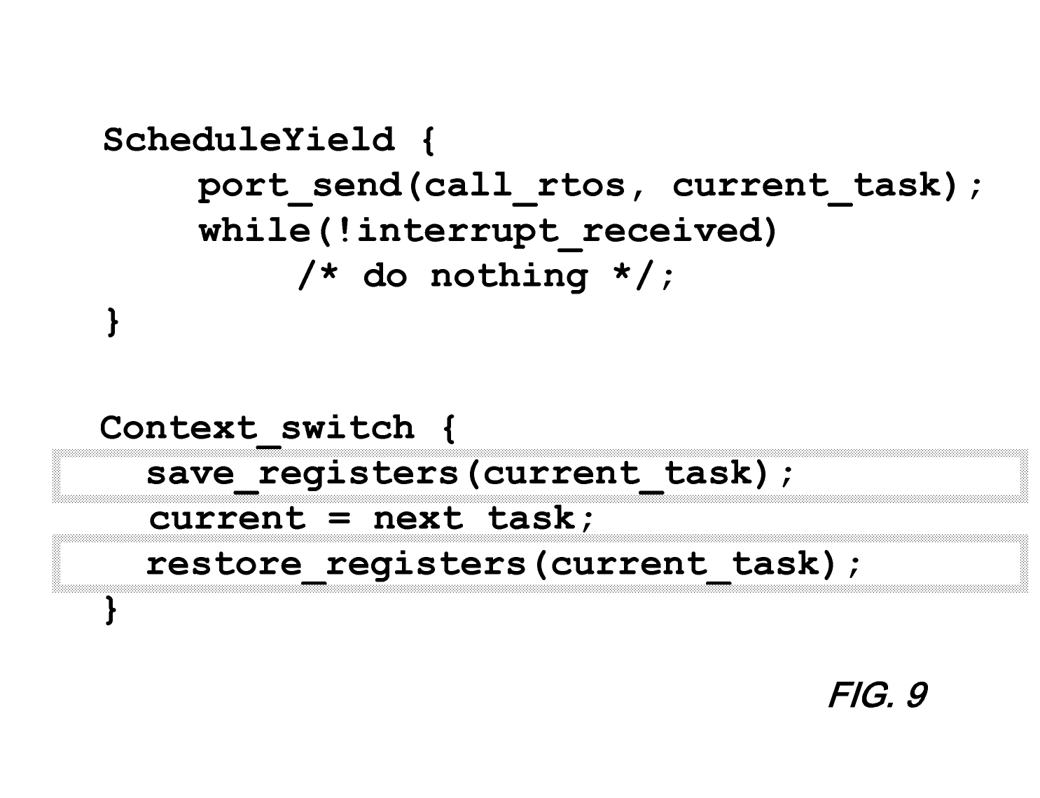

FIG. 9 is a pseudocode listing of the process invoked when a tasks yields control of a processor during its execution. In particular, a call is made to the hardware constituted real-time operating system indicating the task is to be suspended until an interrupt is received. Additionally, a context switch is performed and relevant status of the suspended task is saved in memory until the task is awakened.

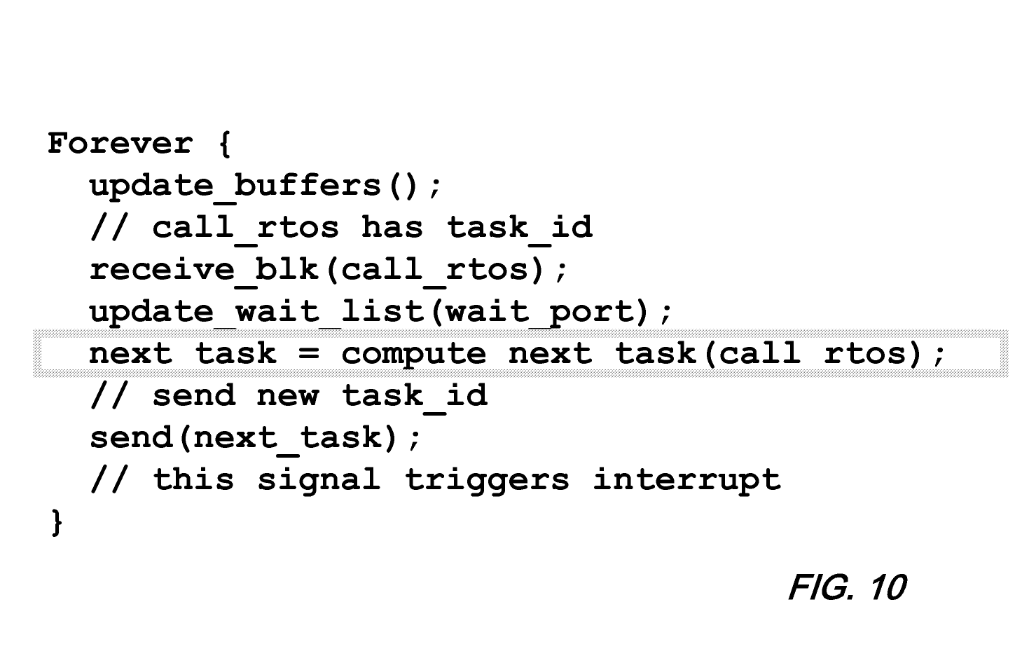

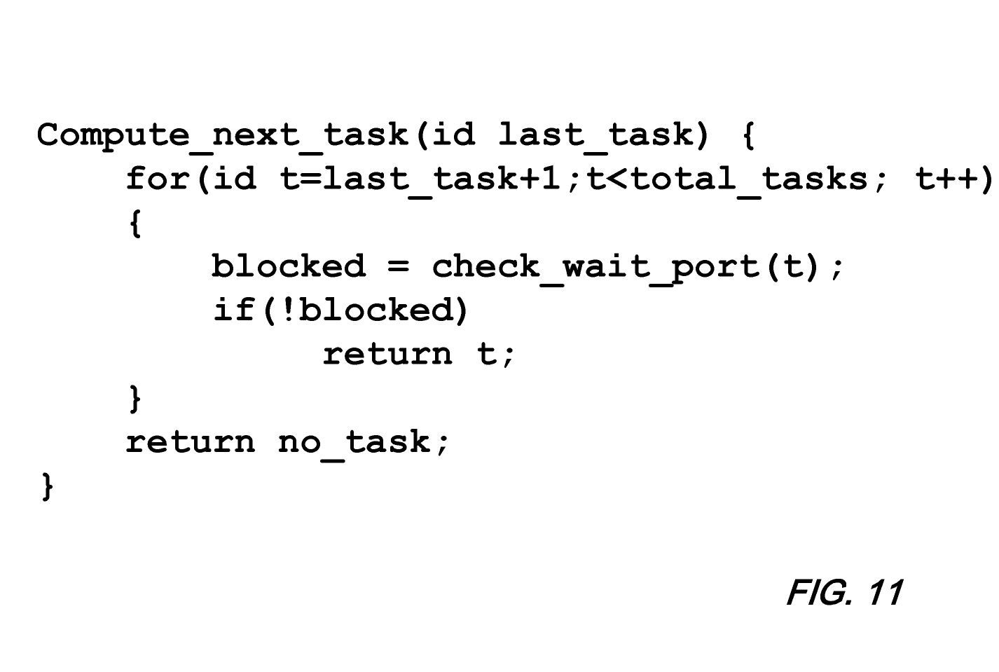

FIG. 10 is a pseudocode listing of the steps associated with notifying the tasks of the next task to be executed while FIG. 11 is a pseudocode listing of the particular steps used to determine the id of the next task to be executed.

At this point, while we have discussed and described the invention using some specific examples, our teachings are not so limited. For example, while we have shown our exemplary invention in a two processor, SMP configuration, additional number(s) of processors may be possible along with alternative bus configurations. Accordingly, the invention should be only limited by the scope of the claims attached hereto.

1. A symmetric multiprocessor system comprising:
two or more symmetric central processors each independently executing a plurality of tasks during the operation of the system;
a memory shared between the central processors;
a hardware constituted real-time operating system; and
a system bus interconnecting the processors, the memory and the real-time operating system hardware;
wherein during the operation of the system the hardware constituted real-time operating system identifies which particular one of the plurality of tasks the processors execute next and provides that identification to the particular processor that is to execute the particular one task next.

2. The system of claim 1 further comprising a lock unit attached to the hardware constituted real-time operating system for coordinating shared access to the memory.

3. The system of claim 2 wherein said hardware constituted real-time operating system includes at least three ports for communicating with the two or more processors through which the real-time operating system indicates the next task to be executed.

4. The system of claim 3 wherein said hardware constituted real-time operating system further comprises a single data handler shared among all processors and two or more hardware schedulers, one for each of the processors.

5. The system of claim 4 wherein each one of said plurality of tasks includes one or more computation nodes and a set of communication nodes for sending and receiving data and scheduled task identification between a particular task and the hardware constituted real-time operating system.

6. The system of claim 5 wherein said three or more ports include a call_rtos port, a wait_port, and a next_task port wherein the wait_port is used by a task to identify a port on which that task is blocked, the call_rtos port is used by the task to trigger a hardware scheduler within the hardware constituted real-time operating system and the next_task port is used to provide the identification of the next task to be executed.
